(19) United States
(12) Patent Application Publication
(10) Pub. No.: US 2002/0166115 A1
(43) Pub. Date: Nov. 7, 2002

(54) SYSTEM AND METHOD FOR COMPUTER PROGRAM COMPILATION USING SCALAR REGISTER PROMOTION AND STATIC SINGLE ASSIGNMENT REPRESENTATION

(76) Inventor: A.V.S. SASTRY, SAN JOSE, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/329,809

(22) Filed: Jun. 10, 1999

(51) Int. Cl. G06F 9/45

(52) U.S. Cl. 717/151; 717/152

(57) ABSTRACT

A scalar register promotion using static single assignment representation (SRP-SSAR) system and method are used in a compiler for optimizing compilation of source code. This optimization uses a promotion algorithm that is profile-driven and is based on the scope of intervals and works on static single representation of a program. The SRP-SSAR system comprises logic which promotes variables that hold scalar values and inserts loads and stores in an enclosing program interval (often natural loops). The system relies on recursive promotion of the outer program interval to propagate these loads and stores to the appropriate program interval. This logic exists in computer memory and is invoked by a user to compile source code into executable code. Use of the present invention significantly reduces memory operations, thereby increasing efficiency.

### FIELD OF THE INVENTION

The present invention generally relates to computer program compilers, and more particularly, to a system and method for providing scalar register promotion using static single assignment representation.

### BACKGROUND OF THE INVENTION

A compiler is a program that reads a program written in one language, the source language, and translates it into an equivalent program in another language, the target language. There are thousands of source languages, ranging from traditional programming languages, such as Fortran and Pascal, to specialized languages that have arisen in virtually every area of computer application. Target languages are equally as varied. A target language may be another programming language or the machine language of any computer or processor.

Although compilers vary greatly in complexity, the basic tasks that any compiler performs are essentially the same. The two parts of compilation are analysis and synthesis. The analysis part breaks up the source program into constituent pieces and creates an intermediate representation of the source program. The synthesis part constructs the desired target program from the intermediate representation. In optimizing compilers today, code optimization is attempted to some degree, in generating the target program from the intermediate representation. Code optimization attempts to improve the intermediate code so that faster running machine code will result. Some optimizations can be trivial, i.e., there is nothing gained and maybe time lost by eliminating an instruction when a calculation could have been done faster with the instruction present. However, there are simple optimizations that significantly improve the running time of the target program without slowing down compilation time too much.

Instructions involving register operands are usually shorter and faster than those involving operands in memory. Therefore, efficient utilization of registers is particularly important in generating good optimized code. The use of registers is often subdivided into two subproblems. First, during register allocation, the set of variables that will reside in registers at a point in the program is selected. Second, during a subsequent register assignment phase, the specific registers that a variable will reside in are selected.

Traditionally, compilers for the well known C programming language allocate global variables in memory. The reason is that global variables are visible throughout the entire program, i.e., the effect of modifying a global variable by a function should be seen by any other function that is called for execution subsequently. With this simplistic allocation strategy, visibility is achieved, but each use of a global variable requires a load instruction and each assignment requires a store instruction. If global variables are used in frequently executed program paths, such as loops, then these loads and stores can degrade program performance significantly. Moreover, the presence of loads and stores can inhibit other optimizations.

Register promotion optimization aims at allocating global variables to virtual registers in certain parts of a program in order to improve the overall program performance. If a variable is promoted to a virtual register in a particular region (i.e., a set of connected nodes with a single entry and multiple exits), loads are inserted at the region's entry, and stores are inserted at the region's exits to ensure that the value in the virtual register and the value in memory are consistent before entering and after exiting the region.

Static single assignment (SSA) form is a widely-used intermediate representation in optimizing compilers. SSA is used to represent the data flow properties of programs. The intermediate code is put into SSA form, optimized in various ways, and then translated back out of the SSA form. Optimizations that can benefit from using SSA form include, but are not limited to, code motion and elimination of partial redundancies, as well as constant propagation.

Some researchers have presented papers on register promotion algorithms to benefit from the advantages of register promotion. For example, J. Lu and K. Cooper, “Register Promotion in C Programs,” Proceedings of the 1997 SIGPLAN Conference on Programming Language Design and Implementation, pp. 308-319, June 1997, which is incorporated herein by reference, presented a loop based register promotion algorithm for scalar variables. For each loop nest, the algorithm computes the set of variables that can be promoted in the loop. Any variable that cannot be analyzed by the compiler is not considered for promotion. For variables that are promotable in a current loop, but not in the enclosing outer loop, loads and stores are inserted at the loop preheader and tails. As this algorithm does not use any type of profiling information, it is restrictive in that the presence of function calls precludes any promotion, even if these calls are executed very infrequently. It is not clear how this algorithm can be extended to incorporate any sort of profile information.

As another example, consider S. Mahlke, “Design and Implementation of a Portable Global Code Optimizer,” M.S. thesis, Dept. of Electrical and Computer Engineering, University of Illinois, Urbana, Ill., Sept. 1992, which is incorporated herein by reference and which presents an algorithm which is loop based and uses profiling information. The global variable migration optimization of the IMPACT compiler described therein promotes global scalar variables, array elements, or local variables in super blocks. Typically, function calls or unknown pointer references that are less frequently executed are not included in a super block. If there are function calls in the super block that are side-effect free, promotion is not attempted in that super block. This algorithm, however, is not designed to work on SSA representation and thus does not gain the desirable benefits of SSA representation.

Neither of the aforementioned methods of register promotion use SSA representation that is profile-driven. Further, neither of the aforementioned methods provide a solution when complete promotion is not possible because function calls or pointer references are present. There is, therefore, a need in the industry for a system and method for addressing these and other related problems.

### SUMMARY OF THE INVENTION

The present invention is generally directed to a system and method for promoting variables that hold scalar variables using static single assignment (SSA) representation.

The program compilation using scalar register promotion using static single assignment representation (SRP-SSAR) system and method uses a compiler which incorporates a register promotion algorithm that traverses each interval in an interval tree and promotes variables in a bottom-up manner. An interval is a strongly connected component of a control flow graph. The program compilation using SRP-SSAR system uses profile information to estimate the benefit of promotion to decide when to promote a variable to a register. If there are function calls or aliased pointer references, then complete promotion may not be possible. In such cases the program compilation using SRP-SSAR system eliminates loads and stores occurring on frequently executed paths by placing loads and stores on the paths containing function calls or pointer references if these paths are executed less frequently. Insertion of stores introduces new SSA names requiring an update of the SSA form. The program compilation using SRP-SSAR system uses incremental updating of the SSA graph when cloned definitions of a variable are added to the program.

According to an aspect of the invention, variables that hold scalar values will be considered for register promotion.

According to another aspect of the invention, global scalar variables are considered for register promotion.

According to yet another aspect of the invention, address exposed local scalar variables are considered for register promotion.

According to still yet another aspect of the invention, scalar components of structure variables are considered for register promotion.

The present invention has many advantages, a few of which are delineated hereinafter, as examples. Note that a patent claim near the end of this document may exhibit one or more (i.e., not necessarily all) of the following advantages, depending upon which aspect of the invention that it is intended to cover.

An advantage of the program compilation using SRP-SSAR system and method is that they allow profile information to be used to estimate the benefit of promotion to decide when to promote a variable to a register.

Another advantage of the program compilation using SRP-SSAR system and method is that they allow the elimination of loads and stores occurring on frequently executed paths by placing those loads and stores on the paths containing function calls or pointer references if these paths are executed less frequently.

Yet another advantage of the program compilation using SRP-SSAR system and method is that they allow incremental updating of the SSA graph when cloned definitions of a variable are added to a program.

Other features and advantages of the present invention will become apparent to one with skill in the art upon examination of the following drawings and detailed description. It is intended that all such additional features and advantages be included herein within the scope of the present invention, as is defined by the claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings, like reference numerals designate corresponding parts throughout the several views.

FIG. 1 is a block diagram illustrating a compiling system of the present invention containing a compiler using the SRP-SSAR system stored on a computer readable medium, for example, in a memory of a computer system;

FIG. 2 is a block diagram illustrating generally the input of a source program into the compiler FIG. 1 and the output of a target program and error messages that result;

FIG. 3 is a block diagram conceptually illustrating the operation phases of the compiler of FIG. 1 which processes a source program into a target program;

FIG. 4A is a textual illustration of the source program of FIG. 2 and FIG. 3, which is situated within a computer readable medium of FIG. 1;

FIG. 4B is a block diagram illustrating the static single assignment representation of the source program of FIG. 4A which is generated by the compiler of FIG. 3;

FIG. 5A is another textual illustration of a different source program of FIGS. 2 and 3, which is situated within a computer readable medium of FIG. 1;

FIG. 5B is a block diagram illustrating the static single assignment representation graph before register promotion created from source program of FIG. 5A by the compiler using SRP-SSAR system of FIG. 1;

FIG. 5C is a block diagram illustrating the static single assignment representation graph after register promotion created from source program of FIG. 5A by the compiler using SRP-SSAR system of FIG. 1;

FIG. 6A is block diagram illustrating a static single assignment representation graph before static single assignment updating by the compiler logic of the present invention shown in FIG. 1;

FIG. 6B is a block diagram illustrating the static single assignment representation graph of FIG. 6A after static single assignment updating and before removing dead phi instructions;

FIG. 7A is a table illustrating the effect of the compiling system using the SRP-SSAR system shown in FIG. 1, on static counts of memory operations;

FIG. 7B is a table illustrating the effect of the compiling system using the SRP-SSAR system shown in FIG. 1, on dynamic counts of memory operations;

FIG. 8 is a table illustrating the effect of register pressure using the compiling system using the SRP-SSAR system shown in FIG. 1.

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

### DETAILED DESCRIPTION OF THE PREFERRED EMBODIMENT

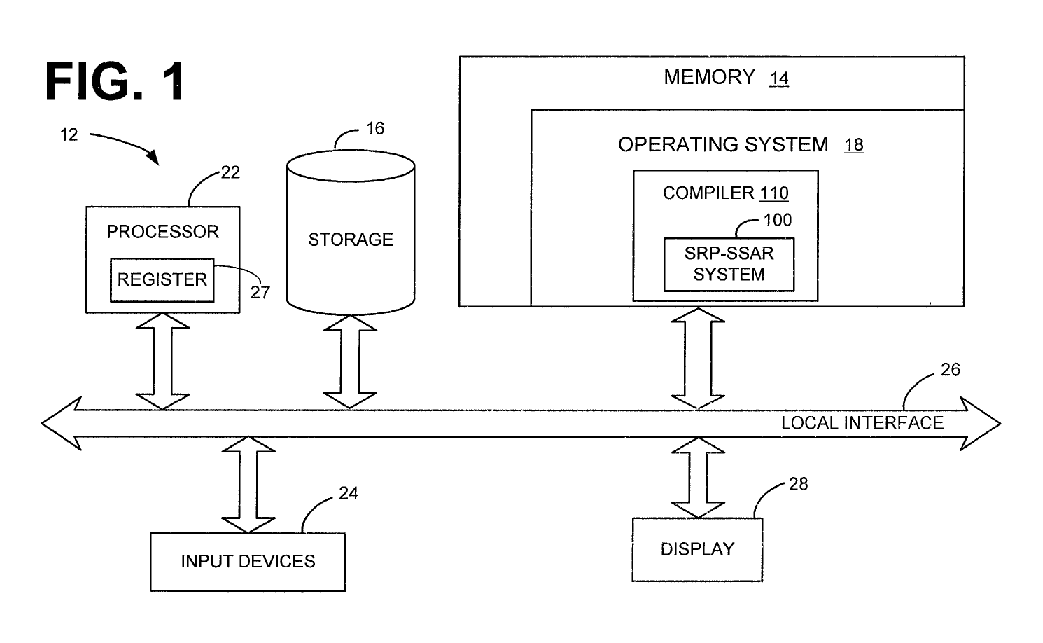

FIG. 1 depicts a system 12 in accordance with the present invention. The system 12 includes a compiler 110 that can be implemented in hardware, software, firmware, or a combination thereof. In the preferred embodiment, the compiler 110 is implemented in software, as is illustrated in FIG. 1 and stored in memory 14 of a computer system, which is generally referred to herein as a “compiling system” 12.

The compiler 110 is logic which is stored in a nonvolatile memory 16, such as a hard disk drive, and is regularly stored into volatile computer memory 14, such as random access memory (RAM), where it interacts with an operating system 18 and processor 22 to process commands from one or more input devices 24 (i.e. a keyboard, mouse, etc.), or other logic in computer memory 14 (i.e. compiler 110) across a local interface 26, such as a bus(es). The processor 22 includes memory, referred to as a register 27, where data can be temporarily stored for a particular purpose. The compiling system 12 may be manipulated by a user using the input devices 24 in starting, setting, or stopping a compilation process. The results of such interaction may be viewed on an output device, for example, a display 28. Further, the SRP-SSAR system 100 is implemented in compiler 110 of the present invention and is used for generating intermediate code of a source program being compiled. The functionality of the SRP-SSAR system shall be further discussed hereinafter.

The compiler 110, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory 14.

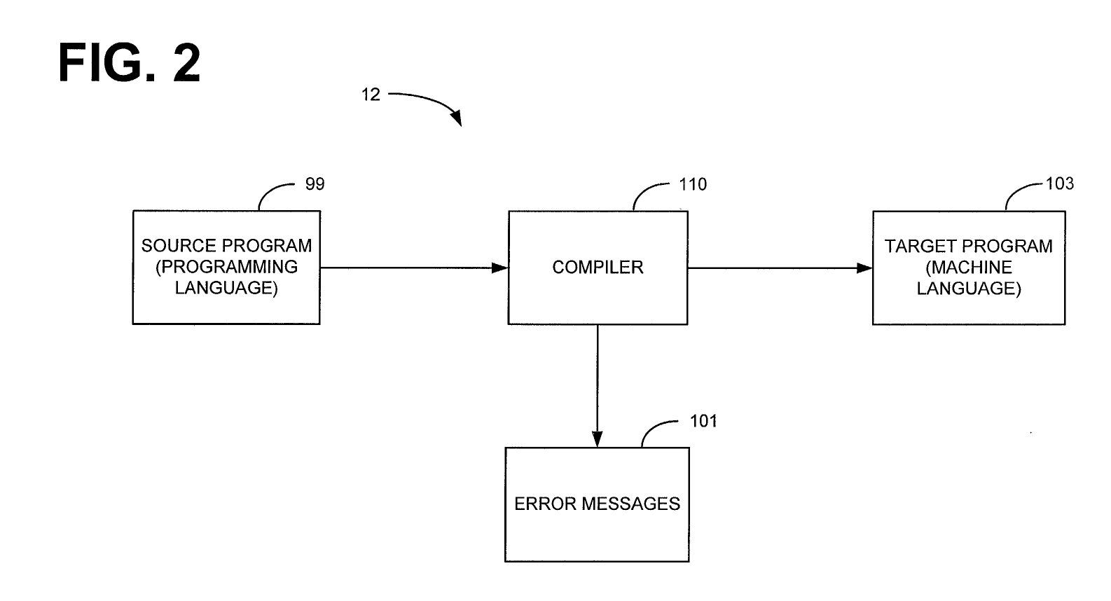

Turning now to FIG. 2, a source program 99 is provided as input to compiler 110 in the compiling system 12. The source program 99 is written by a user and may be written in any one of a variety of programming languages. As output, the compiler 110 checks the user source program 99 for syntactical and other errors and produces error messages 101 or reports for each error discovered by the compiler 110 during the compiling process, which will be desribed in further detail hereinafter. After all errors in the source program 99 have been corrected, the compiler 110 successfully compiles the sources program 99 and, therefore, generates the target program 103, which may be a variety of machine languages or other programming languages.

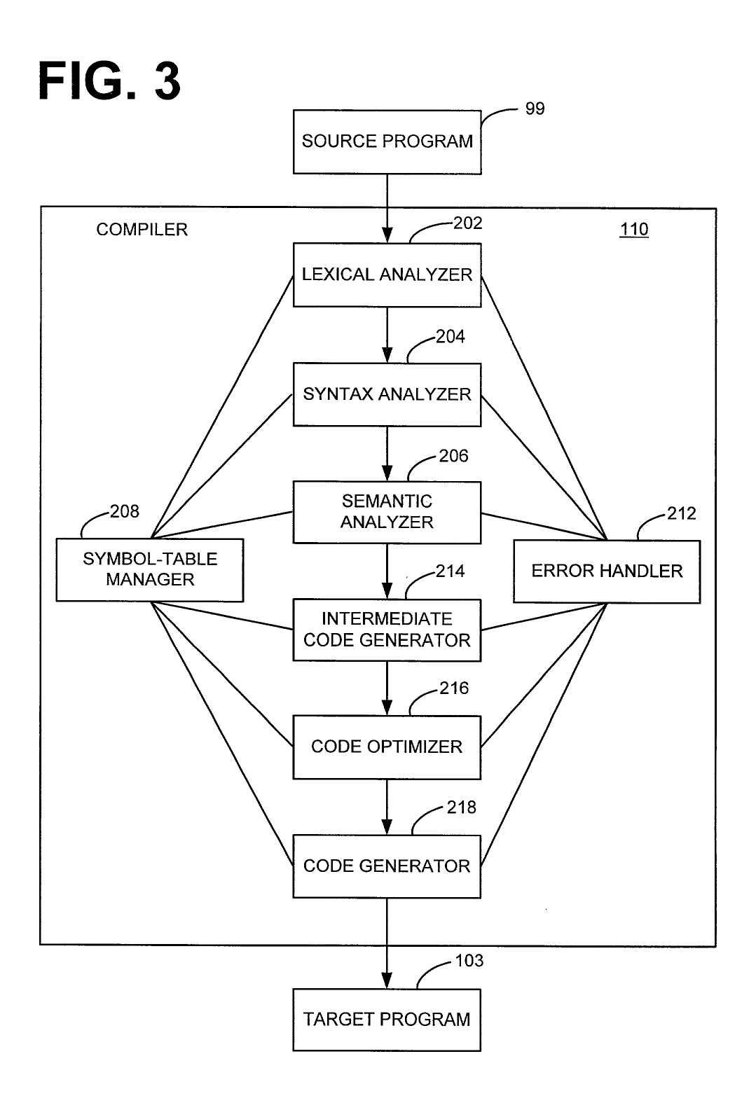

Referring now to FIG. 3, compiler 110 conceptually operates in phases, each of which transforms the source program 99 from one representation to another. In practice, some of the phases 202-206 shown in FIG. 3, may be grouped together or further subdivided. The first three phases form the bulk of the analysis section. These phases 202-206 check the user source program for syntactical and other errors.

The lexical analyzer 202 reads the stream of characters making up the source program 99 and groups the streams into tokens, which are sequences of characters having a collective meaning. The syntax analyzer 204 groups characters or tokens hierarchically into nested collections with collective meanings. The semantic analyzer 206 performs certain checks to ensure that the components of the source program 99 fit together meaningfully. The symbol table manager 208 manages a symbol table, which is a data structure containing a record for each identifier, with fields for the attributes of the identifier. An important function of a compiler 110 is to record the identifiers used in the source program 99 and to collect information about various attributes of each identifier. These attributes may provide information about the storage allocated for an identifier, its type, its scope (where in the program it is valid), and, in cases of procedure names, such things as the number and types of its arguments, the method of passing each argument (e.g. by reference), and the type returned, if any. All phases of a compiler 110 use the symbol table manager 208 for information or updating. Further, since each phase can encounter an error, each phase should know how to deal with that error so that compilation can proceed; hence, each phase of a compiler 110 also uses the error handler 212 for the purpose of handling error conditions.

With further reference to FIG. 3, after the first three analysis phases are complete, the intermediate code generator 214 generates intermediate code of the source program in an intermediate language (IL). This intermediate representation should be easy to produce and easy to translate into the target program 103. Once the intermediate code representation has been generated, the code optimizer 216 attempts to improve the intermediate code, so that faster-running machine code will result. Once the code has been optimized, the final phase of the compiler 110 is the generation of the target program 99, accomplished by the code generator 218, consisting normally of relocatable machine code or assembly code. Memory locations are selected for each of the variables used by the source program 99. Then, intermediate code instructions are each translated into a sequence of machine code instructions that perform the same task. A crucial aspect is the assignment of variables to registers 27.

During translation, the compiler 110 makes many decisions that determine the structure of the code that is eventually generated. A particularly important decision relates to the storage of values; the compiler 110 should determine, for each value, where it will reside at run-time. Generally, these locations are in memory 14 and in registers 27. Since registers 27 are faster to read and write than memory 14, it is generally desirable to keep values in registers 27. This decision gets encoded in the structure of the IL generated for each statement, usually as an explicit assignment of a “virtual register” to each distinct value. “Definitions” target this register and “uses” refer to it directly. Using pointers, situations can arise that prevent retention of a value in a register across statement boundaries. In the absence of specific knowledge about the set of variables that can be referenced by each pointer, the compiler 110 is forced to conservatively treat references to any storage that the pointer might possibly address. In this regard, if a value residing in memory 14 is also stored in register 27, the value in memory 14 and register 27 should be coherent before every pointer load and after every pointer store that can potentially access the value of the variable. In many reduced instruction set computing (RISC) styled compilers, the value of the variable in memory 14 and register 27 is kept coherent by inclusion in the intermediate code of explicit stores and loads for the values that cannot be safely handled.

There are a variety of programming representations that affect how and to what extent a program 99 can be optimized. In the preferred embodiment, the compiler 110 utilizes static single assignment (S SA) form in translating source program 99. Therefore, during the analysis portion of the compiling process, the compiler 110 creates an intermediate representation of the source program 99 that is in SSA form. This intermediate representation is then translated into the target program 103 during the synthesis portion of the compiling process. Representing programs in SSA form is a well known and widely utilized process.

Under SSA form, every source program name has a unique definition. Most source programs have branch and join nodes. At the join nodes, a special form of assignment is added. A phi function with a new definition is inserted at a control flow confluence point to join multiple reaching definitions from different predecessors. A phi function is implemented as an explicit phi instruction in a compiler. SSA form has simplified the design and implementation of some optimizations and has made other optimizations more effective.

In some cases, a complete promotion is not possible because of the presence of function calls or pointer references. Although register promotion can improve program performance by reducing the number of loads and stores executed in the program, it increases register pressure by creating more virtual registers that need to be colored.

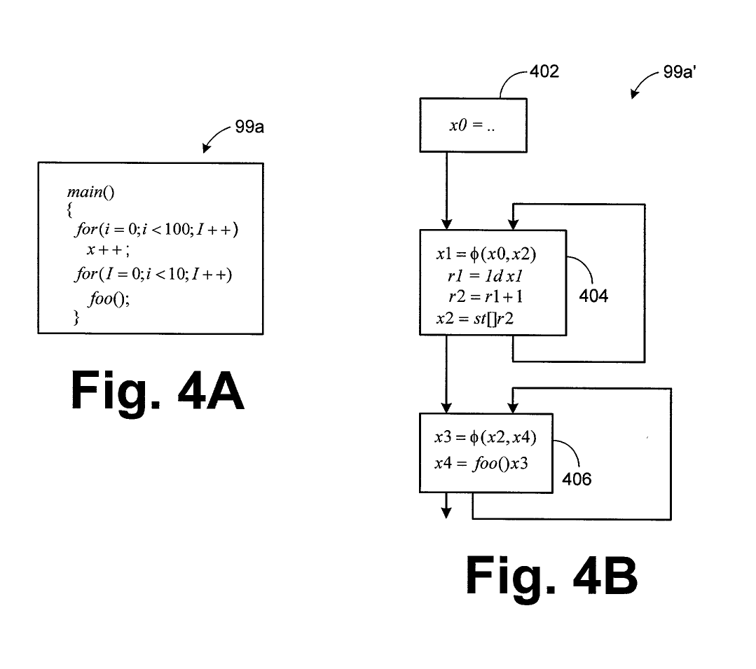

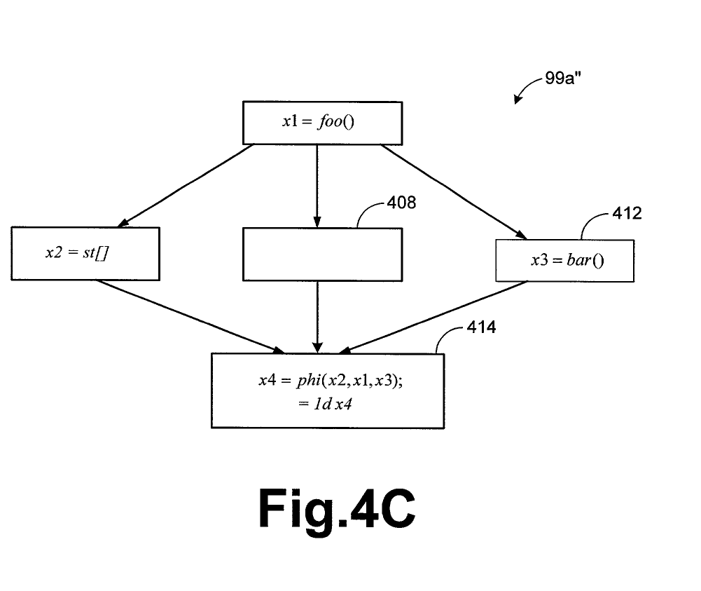

Turning now to FIG. 4A and FIG. 4B, an example of a source program 99a as created by the user is illustrated in FIG. 4A. In the first for loop, the global variable x is incremented 100 times. Before register promotion, variable x has to be loaded from and stored back to memory in every iteration of the first loop. With further reference to FIG. 4B, the SSA representation 99a′ of the source program 99a is shown which results from processing by compiler 110 (FIG. 1) which incorporates the SRP-SSAR system 100 (FIG. 1). Particularly, the SSA representation 99a′ of memory locations is shown. x0 in block 402 represents the x defined before entering the loop. The store to x inside the first loop is renamed to x2, and a phi instruction is inserted at the loop entry in block 404. The function call foo() can potentially modify and use the value of x in block 406. The potential use is reached by x3, which is defined by an inserted phi instruction, and the potential redefinition of x by foo() is renamed to x4 in block 406.

The promotion of the value of x may be based on different scopes. In one scope where the entire program is considered, the value of x is promoted in the first loop into a register. The register value is saved before every ambiguous use of x in the entire program. The register value of x is also reloaded from the memory location of x after every ambiguous definition of x in the rest of the program. In FIG. 4A, promotion within source program 99a would result in inserting a load and a store before and after the call to foo(), respectively. This scope does not consider the structure of the source program 99a. Although the number of loads and stores have reduced from 200 to 21, redundant loads and stores are introduced into the second loop.

In another scope, instead of the entire source program 99a being considered, program intervals (which are often natural loops) are defined and formed into an interval tree, through techniques known in the art. As an example, the process of defining program intervals from a source program is described in “Test Flow Graph Reducability,” Journal of Computer and System Sciences, Vol. 9, p. 355-365, 1974, which is incorporated herein by reference. The intervals are then processed in a bottom-up fashion so that each child interval is processed before its parent interval. Upon entering the interval associated with the first loop in FIG. 4A for processing, the variable x is loaded from memory into a virtual register. Any loads or stores in the interval are replaced by copy instructions based on the virtual register. Upon exiting the interval, the value of the virtual register is stored back to memory. Within the interval, stores are placed before aliased loads, and loads are placed after aliased stores. Using this method, the number of loads and stores for the example in FIG. 4A and FIG. 4B are reduced to two (e.g., a load when entering the first interval and a store after exiting the first interval).

The interval based scope approach assumes that each interval entry or exit edge of an interval is not a critical edge. An edge is a critical edge if its source has multiple successors and its target has multiple predecessors. A critical edge can be removed by inserting a basic block on the edge. The target of an interval exit edge is called a tail and is outside the interval. For loading a value to a virtual register before entering the interval a basic block is needed that strictly dominates all of the basic blocks in the interval. For a proper interval, such a basic block is called a preheader, which is the predecessor of the interval entry excluding the loop back edge. In the case of an improper interval, which has multiple entry basic blocks, the unique preheader for the purpose of register promotion is the least common dominator of all of the entry basic blocks. The driver of the interval based register promotion algorithm is shown in as follows:

promoteInInterval (Interval intvl)

{

for each child interval, ch, of Interval intvl do{

promoteInInterval(ch);

}
//Promote in the current interval.
Set webs = constructSSAWebs(Intvl);
for each web w in webs do{

promoteInWeb(w),

}
cleanup();

}

To identify definitions to and uses from memory locations, memory locations are tagged with unique identifiers called memory resources. A singleton memory resource represents a single memory location. An aggregate resource contains a set, which is accessed or updated as a single indivisible unit, of singleton resources representing multiple memory locations. Aggregate resources are used for expressing the uncertainty in the uses or definitions of memory locations.

A load instruction of a scalar variable is tagged with a singleton resource and is a use of that resource. Similarly a store instruction of a scalar variable defines a singleton resource. A function call, pointer store instruction, or an array assignment defines an aggregate resource, and a function call, a pointer load instruction, or an array reference uses an aggregate resource. A load and a store refer to a singleton load and a singleton store, respectively. For aggregate loads and stores, the terms aliased loads and aliased stores are used and include function calls and pointer references. A function call may modify and use all memory singleton resources that represent global variables. In essence each global variable in the program is associated with a memory resource. Singleton resources are converted to SSA form in order to treat them uniformly with register resources and apply optimizations, such as global value numbering and dead code elimination, to memory instructions as well. An occurrence of a resource in a program is called a reference. Every reference has a resource associated with it.

After SSA construction, more than one singleton resource may represent the same memory location. At the conclusion of SSA forming, all of the singleton memory resources referring to the same memory location should be replaced with one unique name, and the alias sets in aggregate resources should be readjusted to use this name. To accomplish this, the original name of every newly created singleton should be tracked. No more than one SSA name corresponding to a single memory location should be live at any program point.

As aforementioned, after performing SSA renaming, a memory resource gets multiple names. Some of these names are connected through phi instructions. The routine constructSSAWebs(), called in the promoteInInterval() above, constructs SSA webs in a given interval during promotion in the interval. An SSA web is the set of SSA names that are connected to each other by phi instructions. Referring to FIG. 4B, the SSA web consists of {x0, x1, x2, x3, x4}.

Based on the program interval scope promotion approach, a memory SSA web is the unit of promotion within an interval. A memory SSA web in an interval is the set of all singleton memory resources that are connected to each other by phi instructions in the interval. The relation connected between two names: x and y, is defined as follows:

x connected to x

x connected to y, if x and y are operands of a phi instruction in the current interval

This relation is symmetric and reflexive. The transitive closure of the connectivity relation partitions all of the names in the interval into a set of equivalence classes of names called an SSA web or simply a web. A variable definition containing a pointer store or a call, which generates new names, gives rise to multiple webs. Consider the following example:

x=..

foo()

bar()

Both foo() and bar() potentially define and use x. After SSA renaming, the code is represented as follows:

x1=..

x2=foo() uses x1

x3=bar() uses x2

In this example, there are three SSA webs, {x1}, {x2}, and {x3}, corresponding to x, and each of which is considered individually for promotion. Thus the call to bar() need not be considered when promoting x1. Finer grained units of promotion expose more opportunities for promotion. SSA webs in an interval can be constructed by a simple union-find algorithm as shown:

constructSSAWebs(Interval intvl) {

for each resource r in the interval { web(r) = {r}; }
for each phi instruction x₀ = phi(x₁,..., xₙ) of intvl {

rep-x₀ = FIND(x₀); ...; rep-xₙ=FIND(xₙ);
UNION(rep-x₀,..., UNION (rep-xₙ₋₁, rep-xₙ));

}
A web represented by rep-x is all the elements of its set
web(rep-x) = {x₁ | rep-x = FIND (x₁) }

}

Several sets of resources and references associated with a web are defined within the SRP-SSAR system 100. These sets are used by the web promotion algorithm. The set webReferences consists of all the references of the resources of the web. All web references can be collected by scanning the instructions in the interval in a single pass. By processing references in a web, several related sets with a web may be associated to be used later. These sets are as follows:

webResources: The equivalence class of all the names in the web.

webReferences: The set of singleton resources of web defined in the current interval.

defResources: The set of singleton resources of web defined in the current interval.

liveInResource: a unique resource that is defined in an ancestor interval.

loadReferences: The set of references that are singleton loads of the web.

storeReferences: The set of references that are singleton stores of the web.

aliasedLoadReferences: The set of references that can potentially use resources of the web. These correspond to pointer loads and function calls.

LiveOutResources: The set of resources that are defined in the web, but have uses outside the interval.

loads-added: The set of pairs (x,i) where x is a resource, and i is an instruction before which a load of x is inserted.

Stores-added: The set of pairs (x,i) where x is a resource, and i is an instruction before which a store of x is inserted.

The loads-added and stores-added sets are used in determining profitability. The following are some properties of these sets:

There is at most one live-in resource for a web.

Each aliased store defines a unique resource in the web.

Each aliased load uses a unique resource in the web.

There is at most one resource of the web that is live-out of each exit of the interval containing the web.

These properties are based on the fact that the multiple names of singleton resource represent one memory location. Therefore, no two names from the same web can be live at any program point.

Referring now to FIG. 4C where the SSA representation 99a″ of a source program 99a is shown, in order to eliminate existing loads and stores in the web, new loads and stores may have to be inserted on paths containing aliased loads and stores. Promotion is beneficial if the execution frequency of the new loads and stores is less than that of the original loads and stores in the web. If block 408 and block 412 are not very frequently executed, then the load in block 414 can be eliminated by placing loads at the ends of block 408 and block 412. The phi structure of the web is used to identify basic blocks where loads and stores should be added. A phi operand is called a leaf if it is not defined by a phi instruction. The set of loads added is given by:

loads-added={(x,i)|x is a leaf that is not defined by a store of the web and there is an instruction t=phi(. . . , x:L, . . .). and i is the last instruction of basic block L.}

where (x,i) means that a load of resource x has to be added before the instruction i. It is assumed that the last instruction of any basic block is an explicit branch instruction. Examination of the phi instruction indicates that loads have to be added at block 408 and block 412. To determine the program points to add stores, aliased loads are partitioned into two sets, namely the ones using phi resources, and the others using stores of the web. No placement of a store is needed for an aliased load that uses a resource which is either defined outside the current interval or is defined by an aliased store. The stores-added set is determined as:

stores-added={(x,i)|x is a store, and there is a phi instruction t=phi(. . . , x:L, . . .) such that an aliased load depends on t, i is the last instruction in L.}

+{(x,i)|x is a store, and x is used by an aliased load in instruction i. }

If there are two elements (x,i), and (x,j) in the stores-added set and the instruction i dominates j, (x,j) is eliminated from the set. These sets can be computed by scanning the phi instructions of the web and by using the aliasedLoadReferences of the web. The profit of promotion is the difference between the execution frequency of the loads/stores added and the loads/stores deleted. Profit of promotion is determined as follows:

Profit={freq(1dRej)|ldRef is a load reference whose resource is defined by a phi or a store }

+{freq(stRef)|stRef is a store reference }

−{freq(i)|(x,i) is in loads-added}

−{freq(i)|(x,i) is in stores-added}

In some cases, it may be profitable to replace loads, but the profit diminishes if stores are eliminated. Based on the cost of removing stores, a decision can be made not to remove stores. In such cases a variable resides in memory and in a virtual register simultaneously.

As aforementioned, a web is a basic unit for promotion. Within an interval a variable can exist as several SSA memory webs. Each web is considered independently for promotion. This finer distinction of webs make the promotion algorithm more effective. The web promotion algorithm is as follows:

promoteInWeb(web) {

profit = computerProfit(web),
if(profit>=0) {

if (defs() = {}) {

add a load to the preheader and replace
all loads in the web by copy instructions.}

else {

initVRMap();
insertLoadsAtPhiLeaves();
replaceLoadsByCopies(),
if (profitable to remove stores) {

insertStoresForAliasedLoads();
insertStoresAtIntervalTails(),
deleteStores();}
}

if there are aliased loads in web, add a
dummy aliased load in the preheader that
aliases the live-in resource of web.}

else {

if there are aliased loads, loads or stores
in the web then add a dummy aliased load
in the preheader that aliases the live-in resource}

}

For every web, the benefit of promotion is first computed using the aforementioned method for determining profit of promotion. If it is beneficial and there are no definitions in the web, a load is added in the preheader and replace all of the loads in the web by copy instructions. If there are definitions in the web, then the procedure replaceLoadsByCopies() is invoked. This procedure is as follows:

replaceLoadsByCopies() {

for each load “t = ld [x] ”in web {

if (x is defined by a store or a phi instruction) {

v = materializeStoreValue(x);
replace load by a copy “t = v”

}

}

In these steps it is ensured that the program is maintained under SSA form after the loads are replaced by copy instructions. These copy instructions are eliminated by a later phase in the compiler 110.

After having promoted in an inner interval, the information should be summarized for the parent interval. If there are aliased loads, such as function calls and pointer loads, in the inner interval, then it is assumed that the value of the live-in resource must be valid in memory before entering the interval. In order to do so, a dummy load is defined that aliases the liveInResource and add it to the preheader of the interval. Dummy aliased loads prevent the removal of stores in the parent interval, and the algorithm deletes them after promotion. Similarly, if a web could not be promoted for a profitability reason, a dummy load is inserted in the interval preheader.

To facilitate the update of SSA form, a mapping is maintained, called vrMap, from singleton resources to virtual registers. If vrMap[res] is a valid virtual register, then it implies that the value of the singleton memory resource is always available in that virtual register. The routine insertLoadsAtPhiLeaves() adds loads to the web. For each element (x,i) in the loads-added set, it adds a load “t=ld[x]” before the instruction i. The routine replaceLoadsByCopies() shown above replaces each load whose resource is defined by a store or a phi instruction.

The compiler 110 (FIG. 1) containing SRP-SSAR system 100 (FIG. 1) of compiling system 12 (FIG. 1) also provides a procedure to materialize the value of a singleton memory resource in a virtual register. The procedure materializeStoreValue() is as follows:

Resource materializeStore Value(memRes) {

if (memRes −> r is in vrMap) return r;
else {

// memRes must be defined by a phi instruction,
let phi be memRes=phi(x1:L1,...,xn:Ln),
for each phi source xi {
if (xi is a leaf and not a store) {

//there must be a load “t = ld [xi]” in Li
//added by insertLoadsAtLeaves()
ti = t

}
else ti = materializeStoreValue(xi);
}
add the phi instruction “t0 = phi(t1:L1,...,tn:Ln)”
after “memRes=phi(x1:L1,...,xn:Ln)”.
add memRes−>t0 to vrMap
return t0;

}

}

The procedure materializeStoreValue() assumes that all of the necessary loads or copy instructions have been inserted in the web. It recursively visits the connected phi instructions associated with the web to materialize the value of each phi operand and adds it to the vrMap. If a leaf operand of a phi is not defined by a store, the load from the appropriate predecessor basic block of the phi instruction is used. Such a load exists because it was added by the insertLoadsAtPhiLeaves() routine.

The parameter to materializeStoreValue() is defined by a store or a phi instruction. This property holds for the recursive call as well as for the call from replaceLoadsByCopies(). In the routine replaceLoadsByCopies(), for every load “t=1d[x]” that is defined by a phi instruction or a store, the value of x is materialized using materializeStoreValue() and the load is replaced by a copy “t=vrMap[x]”. The program is maintained under SSA form after load replacement.

Store insertion for aliased loads are handled by the routine insertStoresFor AliasedLoads(). For each element (x,i) of the set stores-added, a store, “st[x]=vrMap[x]” is inserted. If there are any web definitions defined by a phi or store instruction in the web that are live outside the interval, stores are inserted in the tail block of each exit edge of the interval. The function insertStoresAtIntervalTails() inserts these stores. Each exit edge has a unique live-out definition which is the immediately dominating definition that reaches the exit block. The store value for liveOutResource is materialized using materializeStoreValue() in each interval tail and that value stored in the tail. Adding new stores creates new SSA names; hence an incremental update of SSA form is performed to accommodate the newly generated names. Both the routines insertStoresForAliasedLoads() and insertStoresAtIntervalTails() perform an incremental update after the stores are inserted in the web.

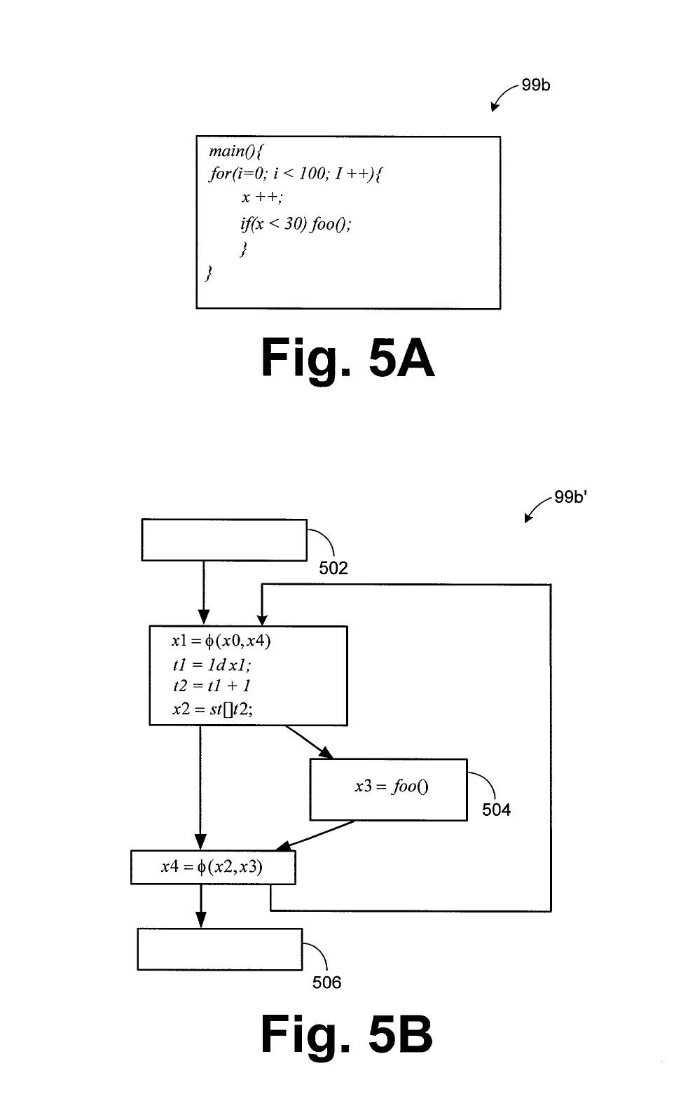

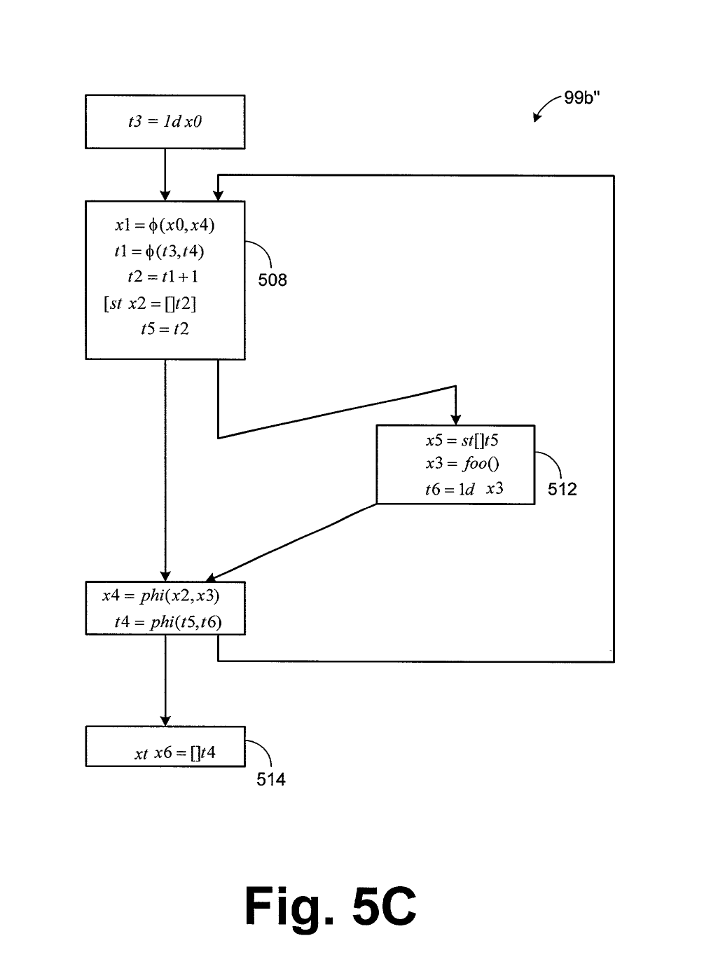

With reference now to FIG. 5A and FIG. 5B, source program 99b is shown in FIG. 5A. Processing source program 99b in compiling system 12 using compiler 110 containing SRP-SSAR system 100, results in the SSA graph 99b′ of FIG. 5B. FIG. 5B shows the SSA graph 99b′ of source program 99b before register promotion. By examining all of the phi instructions in the interval, it is determined that a load of x0 at the end of block 502 should be added and a load of x3 at the end of block 504 should also be added. To eliminate the store, a store before foo() is added. A store has to be added at block 506, which is the tail block. In this example foo() is executed less frequently, so it is beneficial to place a store and a load in block 504.

FIG. 5C illustrates the transformed SSA graph 99b″ of the source program 99b of FIG. 5A after promotion. A copy of t5=t2 is placed in block 508 immediately after the store (store is removed after SSA update). The value of x1 is materialized in a virtual register using materializeStoreValue(). It creates definitions t1 and t4. The value of t5 is stored before the function call in block 512. Assuming that x4 was live-out upon the exit before promotion, its value t4 is stored in the tail block 514. Memory phi instructions which define x1 and x4 become dead after the transformation and thus can be removed. The store in basic block 508 will be deleted after the SSA graph has been updated.

For intervals with multiple exits, multiple stores of a liveOutResource in each of the interval tails should be inserted. Uses of the liveOutResource in the enclosing ancestor intervals may be reached by the new definitions added. In such case, the uses to refer to new definitions have to be renamed. In some cases, both a new and an old definition can reach a use. This would require combining these two definitions using a phi instruction and renaming the use with the phi definition. In general, after insertion of new definitions at the interval tail, the SSA graph 99b″ has to be updated.

The compiler 110 (FIG. 1) incorporating SRP-SSAR system 100 (FIG. 1) in compiling system 12 (FIG. 1) uses a method of incrementally updating an SSA graph when new definitions for an existing resource are introduced in the source program. This method is used to perform the SSA update after store insertion in the register promotion algorithm and is fully described in U.S. Patent Application entitled “An Apparatus and Method to Incrementally Update Static Single Assignment Form for Cloned Variable Name Definitions,” filed on May 4, 1998, and having Ser. No. 09/072,282, which is incorporated herein by reference. The incremental update algorithm is quite general and it can be used in other algorithms such as loop unrolling where multiple definitions are generated for a resource, and for incrementally converting resources to SSA form. When a compiler 110 (FIG. 1) phase adds a new resource with multiple definitions and uses to the code stream, the resource can be converted into SSA form by using the incremental update algorithm.

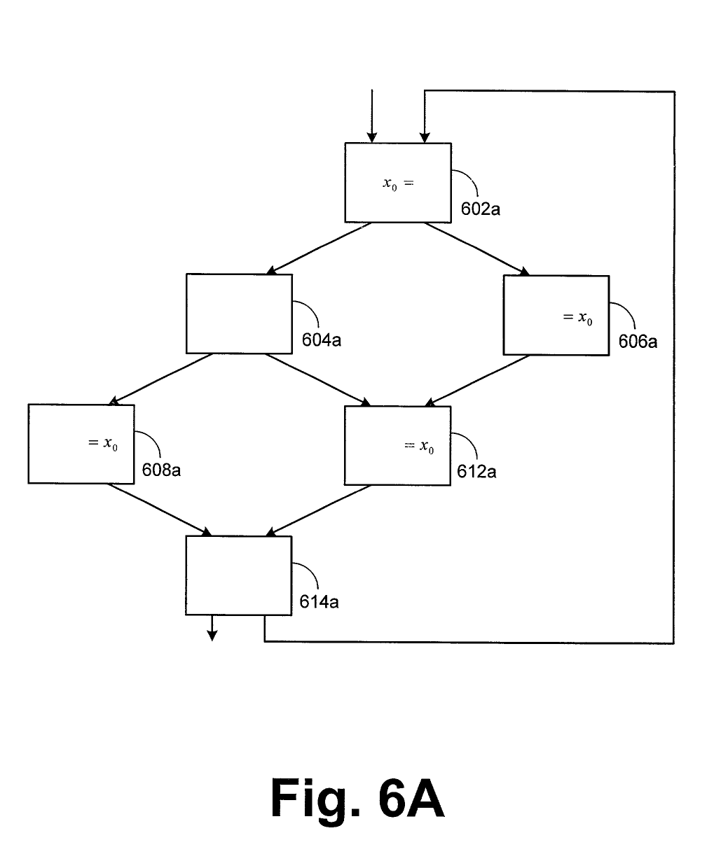

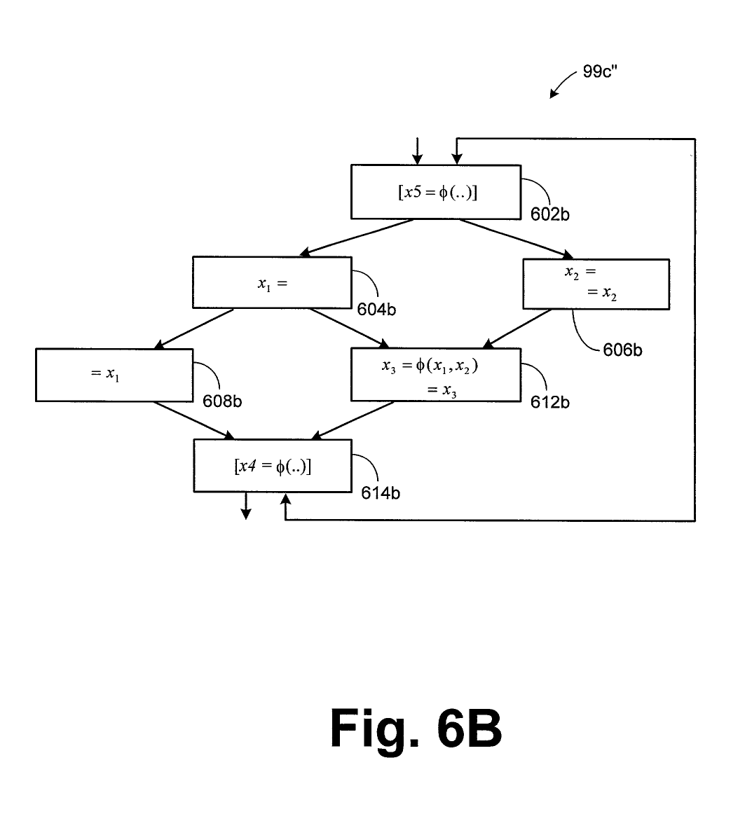

The problem of incremental SSA update for cloned definitions is illustrated by SSA graph 99c′ in FIG. 6A and SSA graph 99c″ in FIG. 6B, which show the original code and transformed code, respectively. There are six basic blocks in this interval, represented on each figure. For simplicity, the edge is not split from block 604a to block 612a or 604b to 612b, respectively. In FIG. 6A, memory resource x₀ is defined in block 602a. Each block 606a, 608a and 612a contains a use of x₀. Assume that register promotion creates two stores: one in block 604a and the other in block 606a while promoting the web containing x₀. To preserve the single assignment property, x0 cannot be the target of any cloned definition. Thus, the target of the new definition in block 604a is named as x₁, and the one in block 606a is named as x₂. With the two new names, phi instructions should be inserted and the original uses of x₀ should be renamed properly as shown in FIG. 6B. Three phi instructions are inserted in blocks 602b, 612b and 614b, respectively, which are the iterative dominance frontier of the basic blocks containing the new definitions, i.e. block 604b and block 606b. Based on the reachability in control flow to be shown in detail in the compiler 110 using the SRP-SSAR system 100, the use at block 606b is renamed x₂, the use at block 608b renamed x₁, and the use at block 612b renamed x₃. The phi instructions at block 614b and at block 602b are dead and can be eliminated because there is no use of the targets, x₄ and x₅. An incremental update algorithm can be used to maintain SSA form.

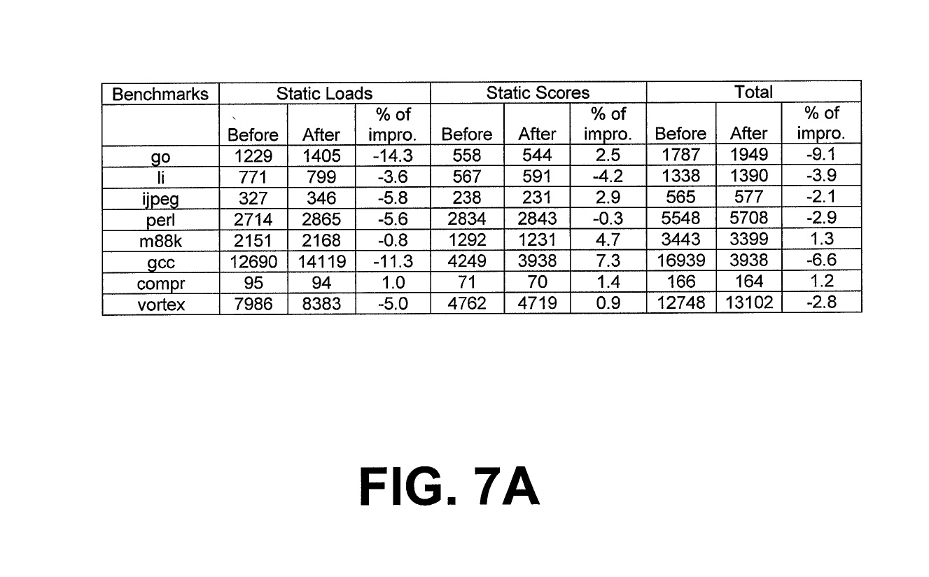

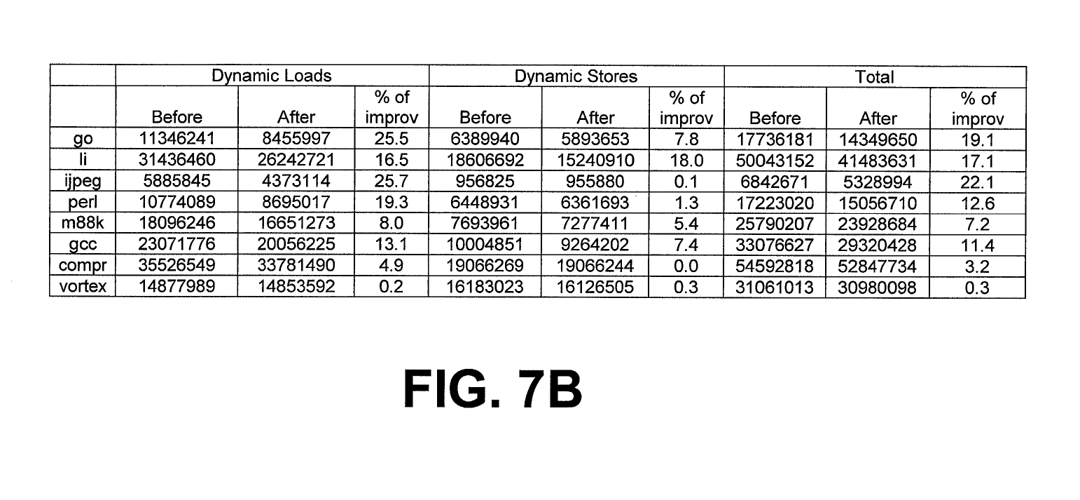

Now referring to FIG. 7A and FIG. 7B, in FIG. 7A, the static numbers of loads and stores before and after the register promotion phase are illustrated. The static number of loads and stores is the number of occurrences of loads and stores in the source program 99, and the dynamic number of loads and stores is the number of loads and stores actually executed during a particular execution of the source program 99. In most benchmarks, the static numbers of loads and stores increase due to register promotion. FIG. 7B illustrates the dynamic cost of memory operations before and after register promotion. In both FIG. 7A and FIG. 7B, loads and stores refer to the singleton loads and stores. Except for “vortex,” there is a significant reduction of memory operations in all of the benchmarks. The benchmark “go” uses a number of global variables including freelist, mvp, etc. which are successfully promoted by the SRP-SSAR system 100. The benchmark “ijpeg” shows a significant reduction in loads even though only a few stores could be eliminated.

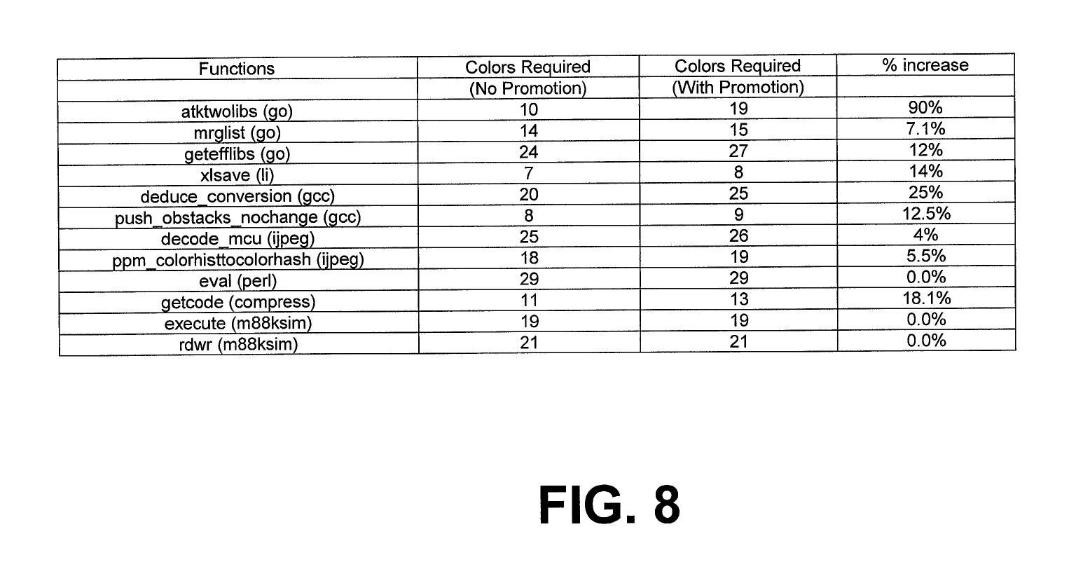

FIG. 8 shows the impact of register promotion on register allocation. For each benchmark, routines were selected that had opportunities for promotion. Further, the number of colors needed to color the register interference graph were computed. Register promotion indeed increases register pressure and requires more registers to color the graph. The effect is more pronounced on routines that require smaller numbers of colors.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the present invention.

I claim:

1. A computer system for compiling source program code into executable program code, comprising:
a memory; and
a program logic resident in said memory of said computer system to define a static single assignment representation of said source program code, to determine at least one program interval associated with said source program code, and to promote a variable in said at least one program interval.

2. The computer system as defined in claim 1, wherein said program logic is further configured to form an interval tree associated with said source program code, said program logic further configured to promote variables in said interval tree in a bottom-up manner.

3. The computer system as defined in claim 1, wherein said program logic is further configured to calculate a benefit of promotion of said at least one variable based on profile information.

4. The computer system as defined in claim 1, wherein said program logic is further configured to replace a load with a copy instruction in promoting said variable.

5. The computer system as defined in claim 1, wherein said computer system comprises a constructor for constructing at least one web in said at least one program interval in said static single assignment representation.

6. The computer system as defined in claim 5, wherein said web includes a set of singleton memory resources connected to each other by a phi instruction in said at least one of said program interval.

7. The computer system as defined in claim 6 wherein said set is an equivalence class with a connectivity relation which is symmetric and reflexive.

8. A method for optimized compilation of source program code into executable program code, comprising the steps of:
defining a static single assignment representation of said source program code;
determining at least one program interval associated with said source program code; and
promoting a variable in said at least one program interval.

9. The method as defined in claim 8, further comprising the step of determining a profitability of said promoting step based on profile information.

10. The method as defined in claim 8, wherein said promoting step further includes the step of replacing a load with a copy instruction.

11. The method as defined in claim 8, further comprising the step of defining at least one web with at least one web reference for said at least one program interval.

12. The method as defined in claim 11, wherein said step of defining at least one web further includes the step of collecting said at least one web reference by scanning at least one instruction in said at least one program interval in at least one program interval pass.

13. The method as defined in claim 8, wherein said step of defining at least one web further includes the step of determining a set of singleton memory resources that are connected to each other by phi instructions in said at least one program interval.

14. The method as defined in claim 13, further comprising the step of inserting a dummy load in a preheader of said program interval.

15. The method as defined in claim 13, further comprising the steps of:
determining whether said promoting step is profitable and whether there are any definitions in said web;
adding a load in a preheader of said web in response to a determination in said determining step that said promoting step is profitable; and
replacing each load located in said web with a copy instruction in response to said determination.

16. The method as defined in claim 15, further comprising the steps of:
defining a dummy load; and
adding said dummy load to said preheader of said program interval.

17. A computer readable medium for optimized compiling of source program code into executable program code, comprising:
logic configured to define a static single assignment representation of said source program code;
logic configured to determine at least one program interval associated with said source program code;
logic configured to define at least one web with at least one web reference for said at least one program interval; and
logic configured to promote at least one variable in said at least one web of said at least one program interval.

18. The computer readable medium as defined in claim 17, wherein said logic configured to promote at least one variable further includes logic configured to compute a benefit of promoting said at least one variable based on profile information.

19. The computer readable medium as defined in claim 17, wherein said logic configured to define at least one web further includes logic configured to determine a set of singleton memory resources that are connected to each other by phi instructions in said at least one program interval.

20. The computer readable medium as defined in claim 19, wherein said logic configured to promote at least one variable further includes:
logic configured to add at least one load in a preheader of said web; and
logic configured to replace each load located in said web with a copy instruction.

21. The computer readable medium as defined in claim 19, wherein said logic configured to promote at least one variable further includes logic configured to replace a load with a copy instruction.
